(19) United States
(12) Patent Application Publication
(10) Pub. No.: US 2006/0102109 A1
(43) Pub. Date: May 18, 2006

(54) Air duct in the front part of a motor vehicle

(75) Inventors: Dirk Becker, Gechingen (DE); Patrick Hoefer, Stuttgart (DE); Martin Konermann, Stuttgart (DE); Ulrich Paetzold, Stuttgart (DE); Sascha Rabensdorf, Weil der Stadt (DE); Jurgen Schreiber, Stuttgart (DE); Creslaw Zolich, Leonberg (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/530,766

(22) PCT Filed: Sep. 18, 2003
(86) PCT No.: PCT/EP03/10389

§ 371 Date: Jan. 3, 2006

(30) Foreign Application Priority Data
Oct. 17, 2002 (DE) 102 48 440.6

(51) Int. Cl. F01P 7/10; B60K 11/04; B60H 1/32

(52) U.S. Cl. 123/41.48; 180/68.4; 62/239

(57) ABSTRACT

The invention relates to an air control system in the front end of a motor vehicle with openings in a front wall defining the front end, through which cooling air flows into a motor compartment. Air ducts (6, 10, 11, 18) are provided which feed the cooling air into athe motor compartment, substantially against the direction of travel and which are formed by boundary walls (7, 19) running approximately parallel to the direction of the air flow. It is therefore the task of the invention that an air guidance is created in the front end of a motor vehicle while assuring a low-loss flow, in which the assembly is substantially simplified.

According to the invention, the boundary walls (17, 19) are integrated into a body panel (1) which extends appromately across the direction of air flow in the motor compartment.

The invention relates to an air control system in the front end of a motor vehicle, according to the introductory part of claim 1.

An air control system in the front end of a motor vehicle is disclosed in DE 38 25 071 C1. In the front end of a motor vehicle openings are created through which cooling air enters into a motor compartment situated behind the front end wall. In the motor compartment air ducts are provided which carry the cooling air to the units that are to be cooled, and they are formed by boundary walls running parallel to the direction of the air flow.

Since the boundary walls are formed by sheet metal parts of the body, they have to be sealed against one another and from the exterior in order to avoid leakage losses and back-flow. This requires increased cost of assembly.

It is therefore the purpose of the invention to create an air control system in the front end of a motor vehicle, in which assembly is substantially simplified.

This purpose is accomplished according to the invention by the characteristics of claim 1.

In a wall defining the front end, openings are created through which cooling air can flow into the motor compartment. The inflowing air is guided by air ducts adjoining the openings to the units in the motor compartment that are to be cooled. The air ducts are formed according to the invention by defining walls integrated into a body panel, the body panel extending approximately across the direction of the air flow. Thus it is possible to align the boundary walls with the body panel such that both a tight connection to the openings is possible, as well as to the units arranged in the motor compartment. The body panel can be swung as a preassembled unit into the front end, together with a cooling module, without the need for additional sealing of the air ducts externally or to one another.

The body panel can have through openings at least partially in the overlapping area of the openings. Due to the arrangement of the body panel in back of the front end wall, the defining walls can extend as far as the openings in the front end wall and be in contact with the marginal area of the opening. Thus the inflowing air cannot be deflected or agitated by projecting parts.

In one embodiment, the boundary walls project approximately at right angles from the marginal areas defining the entrance openings. Sealing flanges are attached all around or shaped so that the ports can be sealed virtually completely from adjoining body areas. Thus unwanted cross flows or turbulence can be suppressed in a simple manner.

The body panel can be disposed most thoroughly behind a bumper unit, and thus serve as a connecting element between the bumper and the cooling module. The body panel in such an arrangement requires no additional fastening measures.

A preferred embodiment consists in the fact that the body panel has a large-area upper through-opening above the flexural beam belonging to the bumper unit. Such an upper opening can be covered with air directing elements of an air-conditioning grille which directs the incoming air to an intercooler arranged in the area covered by the upper opening.

Underneath the flexural beam an additional large-area opening can be provided in the body panel in order to provide cooling air to the cooling units arranged in the lower area.

The lower edge of the upper opening can be shaped so that it is in sealing contact with the back of the flexural beam. Thus eddies or cross-currents between the flexural beam and the interior part of the bumper can be suppressed.

In a preferred embodiment, two circular openings are provided on both sides of the upper opening and from their round marginal areas defining the openings a hollow cylindrical wall projects. Air intake passages can be connected to these connections for an internal combustion motor in the motor compartment. A separate air guiding means can thus be eliminated.

Two additional circular openings can be formed on both sides of the upper opening as through passages of charging air passages. Here not only the sealing but also fastening means for the charging air ducts are eliminated.

An outside corner area of the body panel can be fastened pivotally to the body panel. This has the advantage that during assembly, this corner area can be turned inwardly to save space and turned back out again after assembly.

Additional advantages as well as a preferred embodiment are explained hereinafter with the aid of the drawing, wherein:

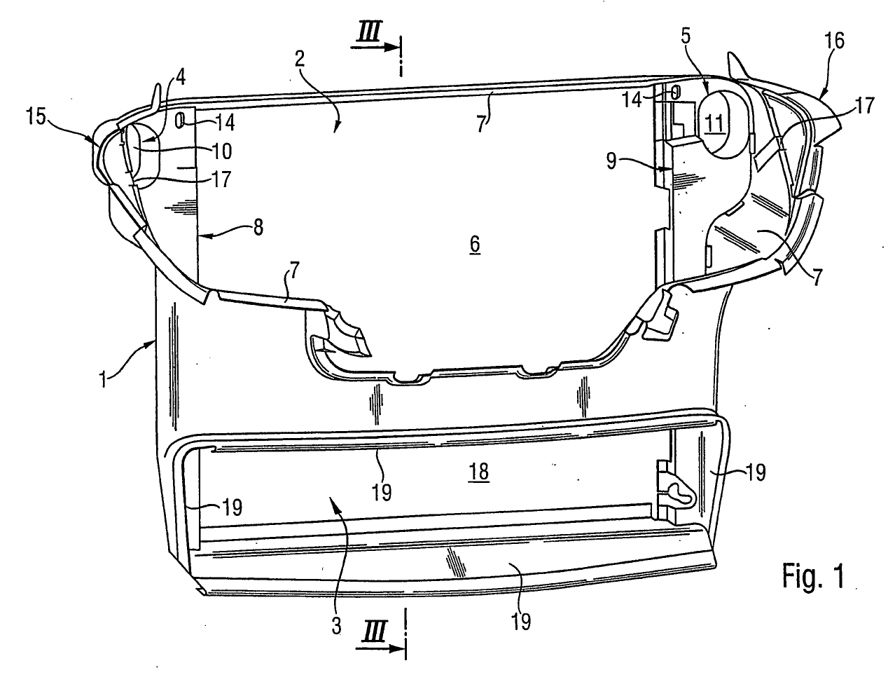

FIG. 1 is a perspective elevation of a body panel taken at an angle from in front,

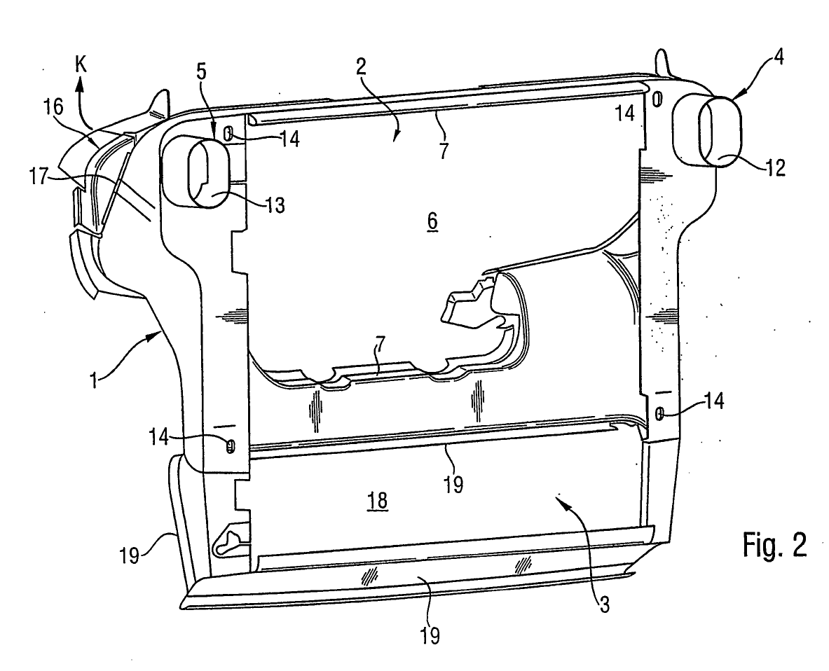

FIG. 2 is a perspective elevation of the body panel of FIG. 1 taken at an angle from behind,

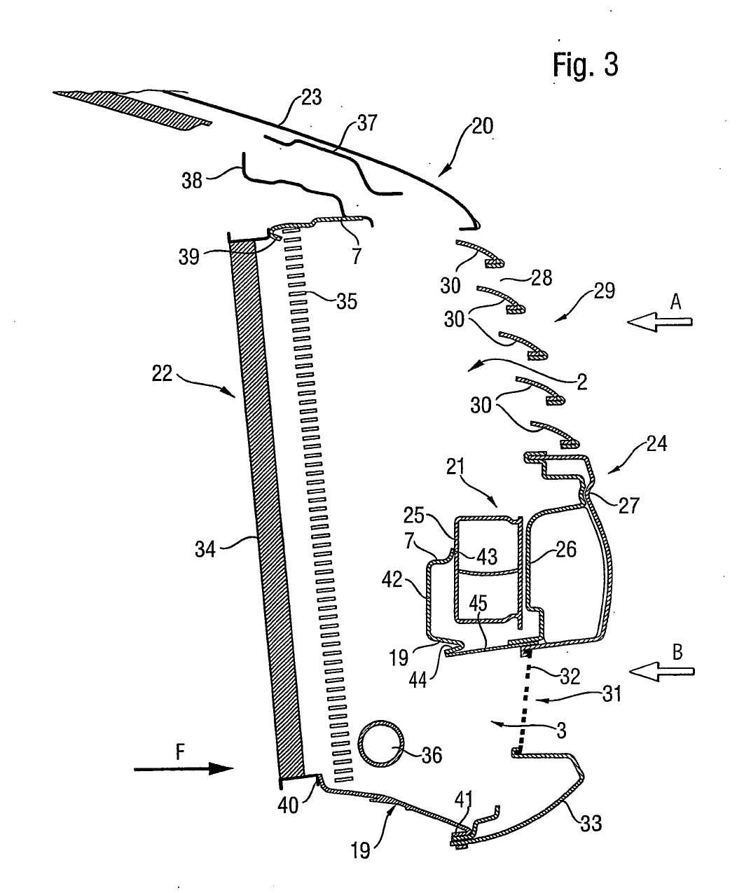

FIG. 3 a longitudinal section taken through a front end of a motor car along line III-III in FIG. 1.

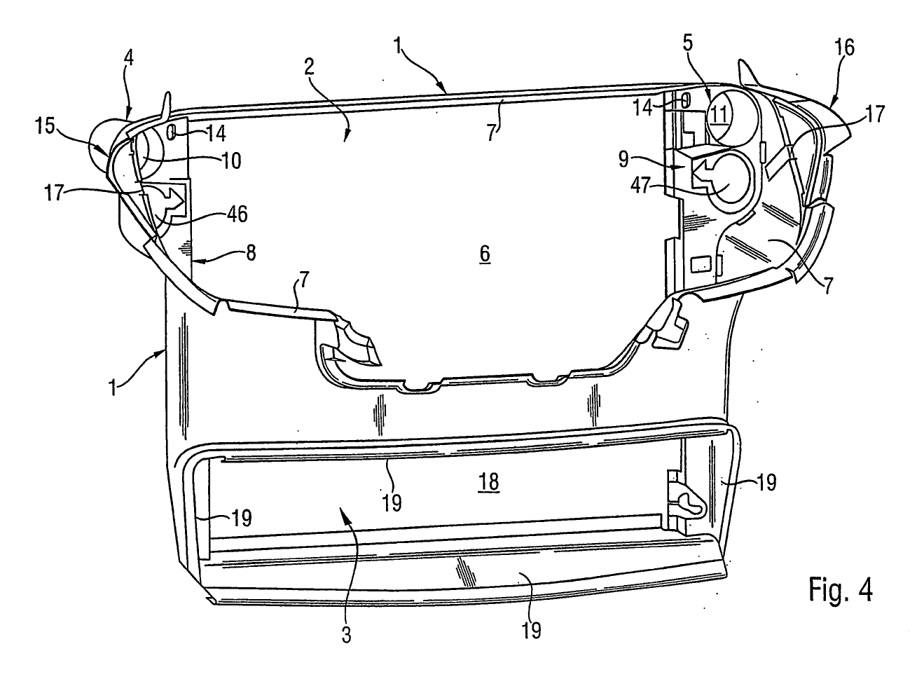

FIG. 4 a second embodiment of a body panel in a perspective elevation seen at an angle from the front, and

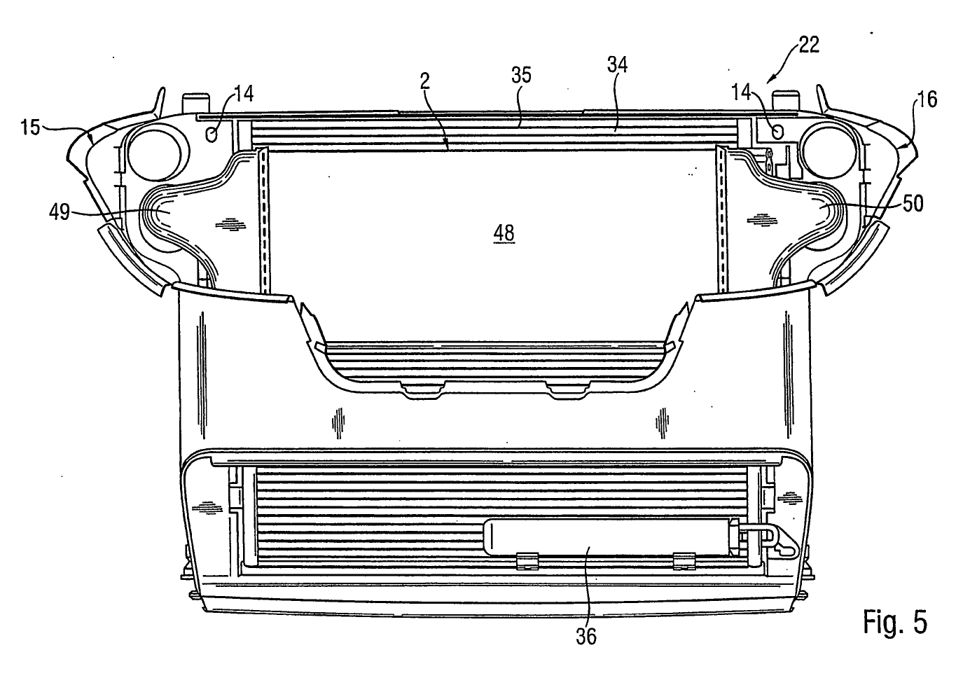

FIG. 5 shows the body panel of FIG. 4 in the installed position with a cooling module.

In FIGS. 1 and 2 body panel 1 is represented in a perspective front and rear view. The body panel 1 has an approximately T-shaped external contour and is provided with air ducts 2, 3, 4 and 5.

The air duct 2 is formed by a opening 6 created in body panel 1, and from its marginal areas circumferential end walls 7 project at approximate right angles. The cross section of the air duct 2 diminishes rearwardly from front to back in the direction of travel, while its exit opening is partially covered at both ends by planar marginal areas 8 and 9.

The air ducts 4 and 5 created in the marginal areas 8 and 9 are formed each by a passage opening 10 and 11, from the marginal area of which a hollow cylindrical defining wall 12 and 13, respectively, projects rearwardly. The boundary walls 12 and 13 form connections for air intake passages of an internal combustion motor situated in the motor compartment. In the marginal areas 8 and 9 fastening eyes 14 are created, which serve to hold body panel 1 in its installed position.

Furthermore, two corner areas 15 and 16 are provided in the upper area of the air duct 2 and are articulated on the wall 7 by a film hinge 17. During assembly, the corner areas 15 and 16 can be folded forward in the direction of the arrow K in order to reduce the width of body panel 1 when it is installed.

The lower air duct 3 is formed by an approximately rectangular opening 18 from whose marginal areas boundary walls 19 project.

In a sectional representation along line III-III in FIG. 1, FIG. 3 shows the arrangement of body panel 1 in the front end 20 of a motor vehicle not further represented.

The front end 20 includes a bumper unit 21 as well as a cooling module 22 and is upwardly defined by an motor hood 23 and forwardly by a front wall 24.

The bumper unit 21 is formed essentially by a flexural beam 25, an inner bumper part 26 and a trim part 27. Above the bumper unit 21 an opening 28 is made in the front wall 24 and is covered by a radiator grille 29. The radiator grille 29 comprises several air directing elements 30 running approximately parallel to one another, which extend across the direction of travel F.

Underneath the bumper unit 21 an additional opening 31 is made in the front wall 24 and is covered by a plastic grille 32. A front-end apron 33 forms the bottom closure of the front wall.

The cooling module 22 comprises a radiator 34, a condenser 35 with an accumulator 36. Above the cooling module 22 two cross plates 37 and 38 are situated closely beneath the motor hood 20.

At the upper end of the cooling module 22 is the boundary wall 7 of the body panel 1 with a hooked sealing flange 39 formed on the back end. With its front end the boundary wall 7 seals the air stream from the cross plate 38.

The body panel 1 lies with a flange 40 of its boundary wall 19 against the bottom end of the cooling module 22. The boundary wall 19 has for its connection to the front-end apron 33 a hooked sealing flange 41 which prevents any uncontrolled flow of the cooling air in this area.

Between the ducts 2 and 3 of the front panel 1 there is a mainly vertical connecting part 42 which is configured so as to assure a seal to the flexural beam 25. For that purpose a flange 43 is formed on the wall 7 forming the upper air duct 2 and lies flatly against the flexural beam 25. On the boundary wall 19 forming the air duct 3 there is formed a sealing flange 44 which lies on a bottom plate 45 inwardly prolonging the inner part 26 of the bumper. Consequently, no appreciable turbulence or crosscurrents can occur on the flexural beam 25.

The air stream developing against the direction of travel F is divided by the openings 28 and 31 into two flows A and B above and below the bumper unit 21.

In FIG. 4 can be seen a second embodiment of the body panel 1, which unlike the embodiment shown in FIGS. 1 to 3, is provided below the connections 12 and 13 for the intake ducts of the internal combustion engine through openings 46 and 47 are provided for cooling the charging air.

For the embodiment of the body panel 1 of FIG. 4, FIG. 5 shows a corresponding pre-manufactured cooling module 22 which can easily be used in the front end of the automobile.

In addition to the radiator 34 and the condenser 35 with accumulator 36, a charging air cooler 48 is associated with the cooling module 22. The charging air cooler 48 extends over virtually the entire width of the air duct 2, and charging air ducts 49 and 50 issuing laterally from the charging air cooler are brought through the ducts 46 and 47.

It is especially advantageous that the body panel 1 is simply suspended by its mounting eyes 14 on projections of the cooling module 22. Thus no additional fastening of the body panel 1 is required after the cooling module 22 is mounted in the front end 20. The width provided by the front end 20 can be achieved by folding over the corner areas 15 and 16 of the body panel 1. After the cooling module has been inserted into the front end the corner areas 15 and 16 can be folded back again and applied sealingly with its boundary walls to the inside shape of the front end.

1. Air control system in the front end of a motor vehicle, which comprises a bumper unit (21) and a cooling module (22), having openings (28, 31) in a front end wall (24) defining the front end (20), through which cooling air flows into a motor compartment, air ducts (2, 3) being provided which deliver the cooling air into the motor compartment, substantially against the direction of travel and which are formed by boundary walls (7, 19) disposed approximately parallel to the direction of the air flow, the boundary walls (7, 19) being integrated into a body panel (1) which extends approximately across the air flow direction and has openings (6, 10, 11, 18) at least partially in the area covered by the openings (28, 31), characterized in that the body panel (1) is fastened to the cooling module (22) and the boundary walls (7, 19) projecting from the marginal areas adjacent the ports (6, 18) are provided at their free ends with circumferential sealing flanges (39, 41, 44).

2. Air control system according to claim 1, characterized in that the body panel (1) is arranged mainly behind a bumper unit (21), the bumper unit (21) comprising a bumper covering (27), a flexural crossbeam (25) and a bumper interior part (26).

3. Air control system according to claim 1, characterized in that one of the openings is a large-area upper opening (6) above the flexural beam (25).

4. Air control system according to claim 1, characterized in that one of the openings is a large-area lower opening (18) beneath the flexural beam (25).

5. Air control system according to claim 3, characterized in that the lower boundary edge (7) of the upper opening (6) of the body panel (1) lies sealingly against the back of the flexural beam (25).

6. Air control system according to claim 5, characterized in that two circular openings (10, 11) are provided on either side of the upper opening (6), from the marginal areas of which adjoining the marginal areas adjacent the openings a hollow cylindrical defining wall (12, 13) projects.

7. Air control system according to claim 6, characterized in that two additional circular openings (46, 47) are provided on both sides of the upper opening (6).

8. Air control system according to claim 1, characterized in that at least one outside corner area (15, 16) of the body panel (1) is joined pivotingly to the body panel (1).
